(19) United States
(12) Patent Application Publication
(10) Pub. No.: US 2026/0214479 A1
(43) Pub. Date: Jul. 23, 2026

(54) ELECTRONIC DEVICE AND METHOD FOR DETECTING ABNORMAL NETWORK TRAFFIC OF APPLICATION

(71) Applicant: ASUSTeK COMPUTER INC., Taipei City (TW)

(72) Inventors: Wei-Cheng Chen, Taipei City (TW); Shih-Chieh Liao, Taipei City (TW); Chin-Hao Chang, Taipei City (TW); Tzu-Hung Chuang, Taipei City (TW); Shih-Chuan Chiu, Taipei City (TW); Chia-Hao Kang, Taipei City (TW); Yi-Nan Lee, Taipei City (TW)

(73) Assignee: ASUSTeK COMPUTER INC., Taipei City (TW)

(21) Appl. No.: 19/445,609

(22) Filed: Jan. 11, 2026

(30) Foreign Application Priority Data
Jan. 21, 2025 (TW) 114102494

(51) Int. Cl. H04W 24/08; H04L 41/142; H04L 47/2475

(52) U.S. Cl. CPC H04W 24/08; H04L 41/142; H04L 47/2475

(57) ABSTRACT

The disclosure provides a method for detecting abnormal network traffic of application thereof. The method includes the following steps. Mobile network traffic data of a plurality of mobile electronic devices is received. The mobile network traffic data of each mobile electronic device includes application network traffic of an application. A statistical analysis processing is performed on the application network traffic of the mobile electronic devices for the application, to obtain an average traffic per unit time of associated with a target unit period for the application. Whether the average traffic per unit time of the target unit period meets a traffic abnormality condition is determined. When the average traffic per unit time of the target unit period meets the traffic abnormal condition, a traffic abnormal version of the application is identified based on the average traffic per unit time of the target unit period.

### CROSS-REFERENCE TO RELATED APPLICATION

This application claims the priority benefit of Taiwan application serial no. 114102494, filed on Jan. 21, 2025. The entirety of the above-mentioned patent application is hereby incorporated by reference herein and made a part of this specification.

### BACKGROUND

### Technical Field

The disclosure relates to an electronic device and a method for detecting abnormal network traffic of application.

### Related Art

The purpose of detecting mobile network traffic of application is to help users understand the data usage of applications under mobile networks, which may avoid additional cost burdens due to abnormal traffic increases. As application functions are continuously updated and complexity increases, network traffic consumption may not only come from user operations, but may also originate from implicit behaviors of applications running in the background or issues with the application programs themselves.

Currently, the main method for detecting mobile network traffic of applications is rely on accumulating the overall traffic of applications and setting a traffic limit by a user. When the accumulated traffic of the application exceeds the limit, the system notifies the user. However, this method cannot accurately determine the root cause of traffic anomalies, that is, the current method cannot distinguish whether the traffic growth is caused by user behavior or program operation. Moreover, relying solely on data analysis of individual cases, without reference to historical big data, makes it difficult to accurately determine whether it is abnormal. In other words, the current existing application traffic monitoring methods have difficulty identifying the fundamental causes of traffic anomalies, and therefore cannot provide users with clear judgment criteria and effective reminders.

### SUMMARY

The disclosure provides a method for detecting abnormal network traffic of applications, which is applicable to electronic devices and includes the following steps. Mobile network traffic data of a plurality of mobile electronic devices is received. The mobile network traffic data of each mobile electronic device includes application network traffic of an application program. A statistical analysis processing is performed on the application network traffic of the mobile electronic devices for the application program, to obtain a average traffic per unit time of target unit time period for the application program. Whether the average traffic per unit time of the target unit time period meets a traffic anomaly condition is determined. When the average traffic per unit time of the target unit time period meets the traffic anomaly condition, a traffic anomaly version of the application program is identified based on the average traffic per unit time of the target unit time period.

The disclosure also provides an electronic device, which includes a storage device and a processor. The processor is coupled to the storage device and configured to execute the following steps. Mobile network traffic data of a plurality of mobile electronic devices is received. The mobile network traffic data of each mobile electronic device includes application network traffic of an application program. A statistical analysis processing is performed on the application network traffic of the mobile electronic devices for the application program, to obtain a average traffic per unit time of target unit time period for the application program. Whether the average traffic per unit time of the target unit time period meets a traffic anomaly condition is determined. When the average traffic per unit time of the target unit time period meets the traffic anomaly condition, a traffic anomaly version of the application program is identified based on the average traffic per unit time of the target unit time period.

Based on the above, in an embodiment of the disclosure, after collecting application network traffic from multiple mobile electronic devices, statistical analysis processing may be performed on the application network traffic generated by multiple mobile electronic devices running an application program, so as to obtain the average traffic per unit time for that application program. Thus, based on the average traffic per unit time obtained through big data analysis of application network traffic from multiple mobile electronic devices, traffic anomaly events of the application program can be detected and the traffic anomaly version of the application program can be retrieved. Accordingly, an objective and reasonable traffic reference for the application program can be obtained to more accurately determine whether abnormal network traffic on a mobile electronic device is caused by the application program.

### BRIEF DESCRIPTION OF THE DRAWINGS

FIG. 1 is a block diagram illustrating an application traffic anomaly detection system according to an embodiment of the disclosure.

FIG. 2 is a flowchart illustrating a method for detecting abnormal network traffic of an application according to an embodiment of the disclosure.

FIG. 3 is a flowchart illustrating a method for detecting abnormal network traffic of an application according to an embodiment of the disclosure.

FIG. 4 is a diagram illustrating the average traffic per unit time of an application program over multiple unit time periods according to an embodiment of the disclosure.

FIG. 5 is a diagram illustrating the calculation of moving average of average traffic according to an embodiment of the disclosure.

FIG. 6 is a flowchart illustrating the identification of abnormal traffic versions according to an embodiment of the disclosure.

FIG. 7 is a diagram illustrating the average traffic of multiple program versions according to an embodiment of the disclosure.

### DESCRIPTION OF THE EMBODIMENTS

Some embodiments of the disclosure will now be described in detail with reference to the accompanying drawings. When the same element symbols appear in different drawings, they will be considered as the same or similar elements. These embodiments are only part of the invention and do not disclose all possible embodiments of the invention. More precisely, these embodiments are only examples of the devices and methods in the scope of claims of the disclosure.

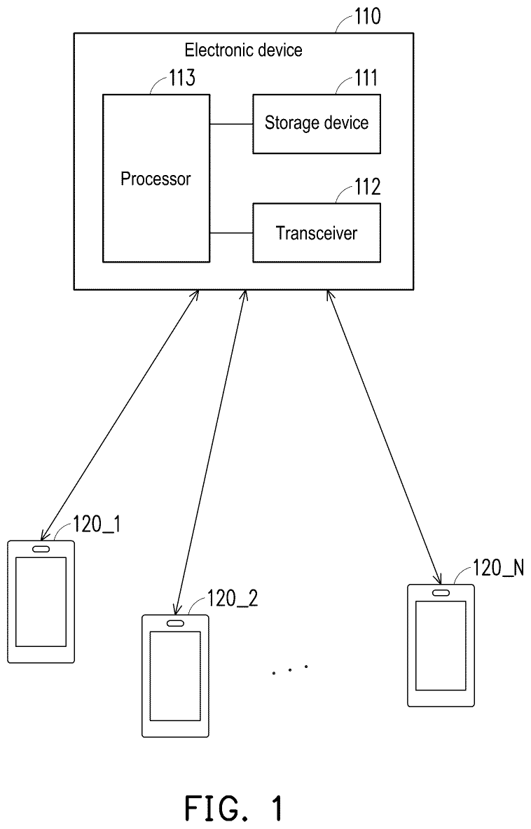

Referring to FIG. 1, which is a block diagram illustrating an application traffic anomaly detection system according to an embodiment of the disclosure. The application traffic anomaly detection system includes an electronic device 110 and multiple mobile electronic devices 120_1 to 120_N. In some embodiments, the mobile electronic devices 120_1 to 120_N may be connected to the electronic device 110 via a network. The mobile electronic devices 120_1 to 120_N are communication devices using mobile communication network (i.e., cellular network), such as smartphones or tablet computers, etc. The mobile communication network may be, for example, a 4G network, 5G network, or future generation mobile communication network.

The mobile electronic devices 120_1 to 120_N may interact with the mobile network through various applications (APPs) and record mobile network traffic data accordingly. In other words, the mobile network traffic data are recorded data generated based on the interaction between the mobile electronic devices 120_1 to 120_N and the mobile network. The mobile network traffic data of the mobile electronic devices 120_1 to 120_N may include application network traffic of one or more application programs. Each of the mobile electronic devices 120_1 to 120_N may provide its own mobile network traffic data to the electronic device 110, enabling the electronic device 110 to perform big data analysis on the application network traffic of multiple mobile electronic devices 120_1 to 120_N.

The electronic device 110 may be, for example, a laptop computer, desktop computer, server, or workstation, or other computing device with processing capabilities. The disclosure does not limit the type of device. In some embodiments, the electronic device 110 may receive the mobile network traffic data from each of the mobile electronic devices 120_1 to 120_N separately via a network. The electronic device 110 may include a storage device 111, a transceiver 112, and a processor 113.

The storage device 111 may be configured to store data and software modules, etc. It may be, for example, any type of fixed or removable random access memory (RAM), read-only memory (ROM), flash memory or other similar devices, integrated circuits or combinations thereof.

The transceiver 112 transmits and receives data wirelessly or via wired connections. The transceiver 112 may also perform operations such as low noise amplification, impedance matching, mixing, up or down frequency conversion, filtering, amplification and similar operations. The transceiver 112 may be configured to receive data provided by the mobile electronic devices 120_1 to 120_N and transmit data to the mobile electronic devices 120_1 to 120_N.

The processor 113 is coupled to the storage device 111, and may be, for example, a general-purpose processor, special-purpose processor, conventional processor, digital signal processor, microprocessor, one or more microprocessors combined with digital signal processor cores, controller, microcontroller, Application Specific Integrated Circuit (ASIC), Field Programmable Gate Array (FPGA), any other type of integrated circuit, state machine or other similar device.

The processor 113 may access and execute software modules recorded in the storage device 111 to implement the method for detecting abnormal network traffic of applications in the embodiments of the disclosure. The aforementioned software modules may be broadly interpreted to mean instructions, instruction sets, code, program code, programs, software packages, threads, procedures, functions, etc., regardless of whether they are referred to as software, firmware, middleware, microcode, hardware description language or otherwise.

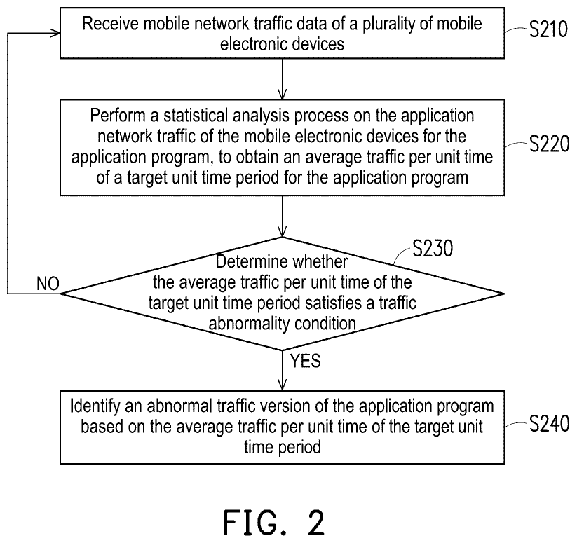

FIG. 2 is a flowchart illustrating a method for detecting abnormal network traffic of applications according to an embodiment of the disclosure. Referring to FIG. 1 and FIG. 2, the method of this embodiment is applicable to the electronic device 110 in the aforementioned embodiment. The following detailed steps of the method for detecting abnormal network traffic of applications in this embodiment will be explained in conjunction with the various components of the electronic device 110.

In step S210, the processor 113 may receive mobile network traffic data of a plurality of mobile electronic devices 120_1 to 120_N. The mobile network traffic data from each mobile electronic device 120_1 to 120_N includes application network traffic of an application program. The application network traffic of the application program may include the uplink and downlink data volume (in KB or MB) of the application program per unit time. For example, the mobile network traffic data from each mobile electronic device 120_1 to 120_N includes daily application network traffic for each application program.

In some embodiments, the application network traffic is background mobile network traffic. Specifically, background mobile network traffic refers to the automatic data exchange generated when the application program runs in the background, such as automatic version updates, push notifications, and data synchronization operations performed by the application. Based on this, since the processor 113 detects traffic anomalies of the application according to the background mobile network traffic of a particular application program from each mobile electronic device 120_1 to 120_N, it can exclude interference caused by foreground network traffic generated by user operations. Therefore, whether the application program is performing abnormal traffic behavior in the background may be accurately identified.

In step S220, the processor 113 may perform statistical analysis processing on the application network traffic of the application program for the mobile electronic devices 120_1 to 120_N to obtain an average traffic per unit time of the target unit time period for the application program. In other words, based on the application network traffic for each unit time period provided by the mobile electronic devices 120_1 to 120_N, the processor 113 may calculate the average traffic per unit time for each unit time period (for example, daily, but not limited to this) for each application program.

For example, mobile electronic devices 120_1 to 120_N may respectively provide the application network traffic of a certain application program on a specific date of a certain month to the electronic device 110. The electronic device 110 may perform average calculation on N pieces of application network traffic data of the specific date provided by N mobile electronic devices 120_1 to 120_N to obtain the average traffic per unit time of the specific date for that application program. In other words, the average traffic per unit time for the target unit time period is generated by statistically averaging the application network traffic provided by multiple mobile electronic devices 120_1 to 120_N.

In step S230, the processor 113 may determine whether the average traffic per unit time of the target unit time period meets a traffic anomaly condition. In some embodiments, the processor 113 may compare the average traffic per unit time of the target unit time period with the long-term average traffic to determine whether the average traffic per unit time for the target unit time period meets the traffic anomaly condition. The aforementioned long-term average traffic may be determined by analyzing the application network traffic of mobile electronic devices 120_1 to 120_N over a long period of time. Furthermore, in some embodiments, the processor 113 may determine whether the average traffic per unit time for the target unit time period shows an increasing trend compared to the average traffic per unit time of multiple historical time periods in the past, to determine whether the average traffic per unit time for the target unit time period meets the traffic anomaly condition.

In step S240, when the average traffic per unit time of the target unit time period meets the traffic anomaly condition, the processor 113 may identify the traffic anomaly version of the application program based on the average traffic per unit time of the target unit time period. Specifically, the processor 113 may analyze the differences in background traffic behavior of the application program across different versions to identify the traffic anomaly version that may cause the traffic anomaly. As a result, the cause of the traffic anomaly can be more accurately pinpointed, and more effective improvement measures can be proposed accordingly.

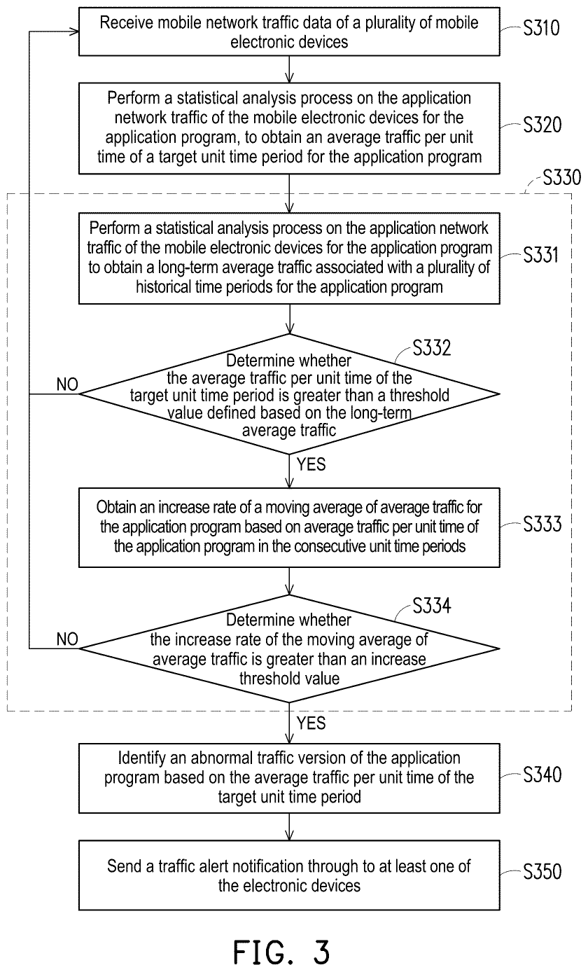

FIG. 3 is a flowchart illustrating a method for detecting abnormal network traffic of an application program according to an embodiment of the disclosure. Referring to FIG. 1 and FIG. 3, the method of this embodiment is applicable to the electronic device 110 in the aforementioned embodiment. The following detailed steps of the method for detecting abnormal network traffic of an application in this embodiment will be explained in conjunction with the various components in the electronic device 110.

In step S310, the processor 113 may receive mobile network traffic data of multiple mobile electronic devices 120_1 to 120_N. The mobile network traffic data from each mobile electronic device 120_1 to 120_N includes application network traffic of an application. In step S320, the processor 113 performs statistical analysis on the application network traffic of the mobile electronic devices 120_1 to 120_N for the application program to obtain the average traffic per unit time of the target unit time period for the application program. The explanation of the above steps may be referred to the description in the previous embodiment, which will not be repeated here.

In step S330, the processor 113 may determine whether the average traffic per unit time of the target unit time period meets the traffic anomaly condition. In some embodiments, step S330 may be implemented as steps S331 to S334.

In step S331, the processor 113 may perform statistical analysis processing on the application network traffic from the mobile electronic devices 120_1 to 120_N for the application program to obtain a long-term average traffic associated with multiple historical time periods for the application program. Specifically, the processor 113 may analyze the application network traffic from multiple mobile electronic devices 120_1 to 120_N over the past several tens of days (for example, the past 50 days, i.e., multiple historical time periods) for the application program, thereby obtaining a long-term average traffic for the application program. The long-term average traffic can be considered as a normal traffic value under normal circumstances.

In step S332, the processor 113 may determine whether the average traffic per unit time exceeds a threshold value defined based on the long-term average traffic. Specifically, the processor 113 may decide a threshold value based on the long-term average traffic from multiple historical time periods in the past, and determine whether there is an anomaly in the average traffic per unit time of the target unit time period based on this threshold value.

In some embodiments, the processor 113 may calculate standard deviation data based on the application network traffic from the mobile electronic devices 120_1 to 120_N over multiple historical time periods. Then, the processor 113 decides the threshold value based on the standard deviation data and the long-term average traffic. Specifically, the processor 113 may analyze the application network traffic from multiple mobile electronic devices 120_1 to 120_N over multiple historical time periods for the application program, thereby obtaining a long-term average traffic and a standard deviation. Subsequently, the processor 113 may decide the threshold value based on the long-term average traffic and the corresponding standard deviation through table lookup or function calculation.

For example, the processor 113 may decide the threshold value according to the following formula (1).

$$\\ \begin{matrix}m3d\_threshold = ( base ABMT + 3 \times base SD ) & formula ( 1 )\end{matrix}$$

wherein m3d_threshold is the threshold; base ABMT is the long-term average traffic; base SD is the standard deviation. The processor 113 may determine whether the average traffic per unit time of today exceeds m3d_threshold.

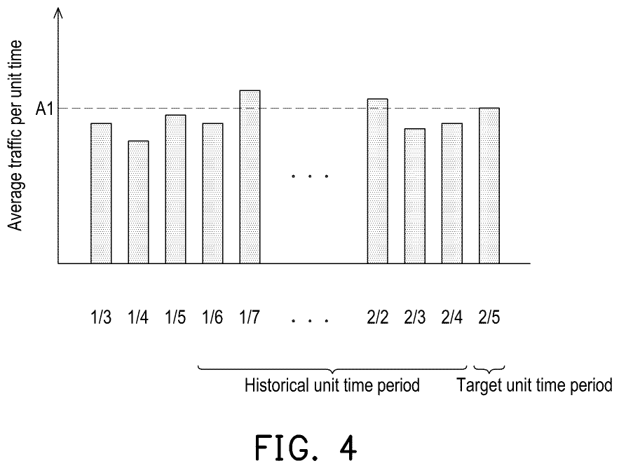

For example, referring to FIG. 4, which is a schematic diagram illustrating the average traffic per unit time of an application over multiple unit time periods according to an embodiment of the disclosure. By analyzing the daily application network traffic from multiple mobile electronic devices 120_1 to 120_N, the processor 113 may obtain the average traffic per unit time for an application program for everyday. Additionally, the processor 113 may calculate the long-term average traffic and standard deviation data from multiple sample data over multiple historical time periods (i.e., January 6 to February 4). The processor 113 may determine whether the average traffic per unit time “A1” of the target unit time period (i.e., February 5) exceeds the long-term average traffic of the multiple historical time periods plus 3 times the standard deviation.

When step S332 is determined as yes, proceed to step S333. In step S333, the processor 113 may obtain the increase rate of the moving average of average traffic for the application program based on multiple average traffic per unit time values over multiple consecutive unit time periods. The multiple consecutive unit time periods include the target unit time period. In step S334, the processor 113 may determine whether the increase rate of the moving average of average traffic exceeds an increase threshold value. In other words, the processor 113 may determine whether the average traffic per unit time of the application program over multiple consecutive unit time periods shows an upward trend. The increase threshold value may be set according to actual conditions, and the disclosure does not limit this.

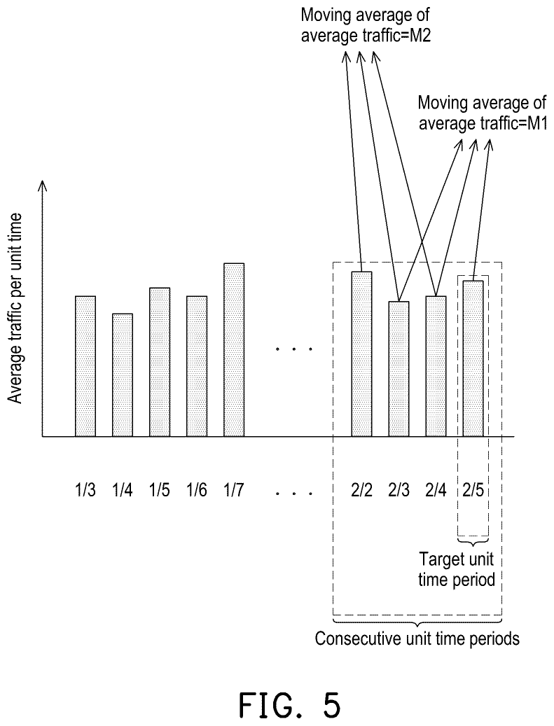

For example, referring to FIG. 5, which is a schematic diagram illustrating the calculation of the moving average of average traffic according to an embodiment of the disclosure. By analyzing the daily application network traffic from multiple mobile electronic devices 120_1 to 120_N, the processor 113 may obtain the average traffic per unit time for an application program daily. The processor 113 may calculate a moving average of average traffic M1 based on three average traffic per unit time values from February 3 to February 5. The processor 113 may calculate a moving average of average traffic M2 based on three average traffic per unit time values from February 2 to February 4. The processor 113 may calculate the increase rate of the moving average of average traffic by subtracting the moving average of average traffic M2 from the moving average of average traffic M1. For example, the processor 113 may decide the increase rate of the moving average of average traffic according to the following formula (2).

$$\\ \begin{matrix}increase rate = \frac{M 1 - M 2}{M 1} \times 100 \% & formula ( 2 )\end{matrix}$$

In the embodiment in FIG. 3, when the average traffic per unit time of the target unit time period is greater than the threshold value determined based on the long-term average traffic, and the increase rate of the moving average of average traffic is greater than the increase threshold value, the average traffic per unit time of the target unit time period meets the traffic anomaly condition. In other words, when the average traffic per unit time of the target unit time period is greater than the threshold value, and the average traffic per unit time over multiple consecutive unit time periods shows an upward trend, the processor 113 may determine that the average traffic per unit time of the target unit time period meets the traffic anomaly condition, and mark the target unit time period as an anomalous period. In some embodiments, the processor 113 may decide the long-term average traffic and its corresponding threshold value under the condition of excluding the traffic data of the aforementioned anomalous period.

Subsequently, in step S340, when the average traffic per unit time of the target unit time period meets the traffic anomaly condition, the processor 113 may identify the traffic anomaly version of the application program based on the average traffic per unit time of the target unit time period. Specifically, when the processor 113 determines that a traffic anomaly event of the application program has occurred, based on the average traffic per unit time of all application versions and the average traffic per unit time of each different version, the processor 113 may identify the traffic anomaly version from these application versions.

In step S350, based on the traffic anomaly version of the application program, the processor 113 may send a traffic alert notification through the transceiver 112 to at least one of multiple electronic devices 120_1 to 120_N. In some embodiments, the processor 113 may send a traffic alert notification to multiple electronic devices 120_1 to 120_N to notify them of the existence of a traffic anomaly situation in the traffic anomaly version of the application program. Thus, when the electronic devices 120_1 to 120_N are about to update to the traffic anomaly version or have already installed the application with the traffic anomaly version, the electronic devices 120_1 to 120_N may execute corresponding traffic control strategies. For example, the electronic devices 120_1 to 120_N may prompt the user that the currently installed version has a network traffic anomaly, or perform a traffic restriction operation on the application program with the traffic anomaly version. The aforementioned traffic restriction operation may be prohibiting the application program from running in the background, limiting the maximum daily network traffic that the application program can transmit, or restricting the application program from automatically starting.

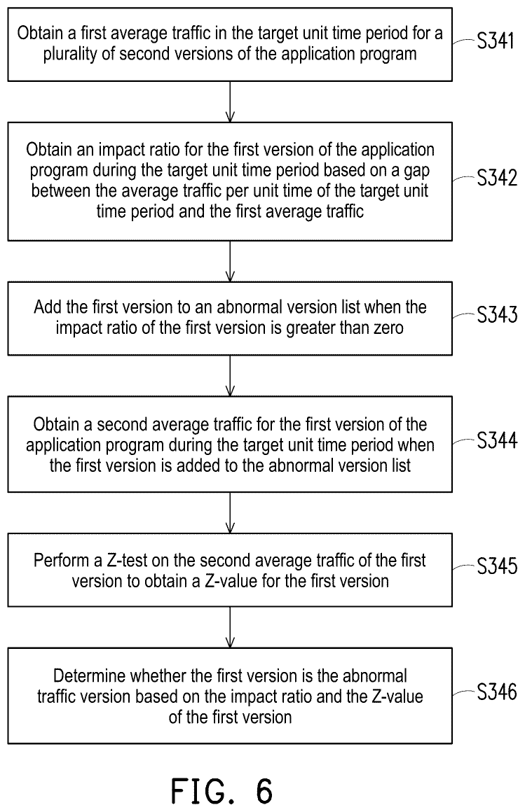

Referring to FIG. 6, which illustrates a flowchart of identifying an anomalous traffic version according to an embodiment of the disclosure. In some embodiments, multiple program versions of the application program include a first version and multiple second versions. Specifically, the first version is any one of the multiple program versions, while the multiple second versions are the others among the multiple program versions.

In step S341, the processor 113 may obtain a first average traffic of multiple second versions of the application program in the target unit time period. In other words, the processor 113 may calculate the first average traffic without taking into account the application network traffic of the first version. On the other hand, the average traffic per unit time of the target unit time period is based on the statistical results of all multiple program versions.

In some embodiments, the processor 113 may decide whether the first version is a traffic anomaly version based on the gap between the average traffic per unit time associated with multiple program versions and the first average traffic not associated with the first version.

In step S342, the processor 113 obtains an impact ratio of the first version of the application program in the target unit time period based on the gap between the average traffic per unit time and the first average traffic.

For example, the processor 113 may decide the Impact Ratio according to the following formula (3).

$$\\ \begin{matrix}{IR}_{v} = \frac{today ABMT - ABMT\_v}{today ABMT} \times 100 \% & formula ( 3 )\end{matrix}$$

Wherein IRᵥ is an impact ratio of the first version in the target unit time period; today ABMT is an average traffic per unit time of all program versions in the target unit time period; ABMT_v is a first average traffic of the target unit time period calculated without using data of a first version.

In step S343, when the impact ratio of the first version is greater than zero, the processor 113 may add the first version to an anomaly version list. Specifically, based on the application network traffic corresponding to different versions reported by the mobile electronic devices 120_1 to 120_N, the processor 113 may obtain the average traffic per unit time associated with all versions and the first average traffic excluding a certain version. According to the average traffic per unit time associated with all versions and the first average traffic excluding a certain version, the processor 113 may analyze the impact degree of the excluded version on abnormal traffic, thereby judging whether the excluded version is a traffic anomaly version. When the Impact Ratio is positive, it indicates that the traffic of the excluded version (i.e., the first version) is relatively high, so the first version is added to an anomaly version list.

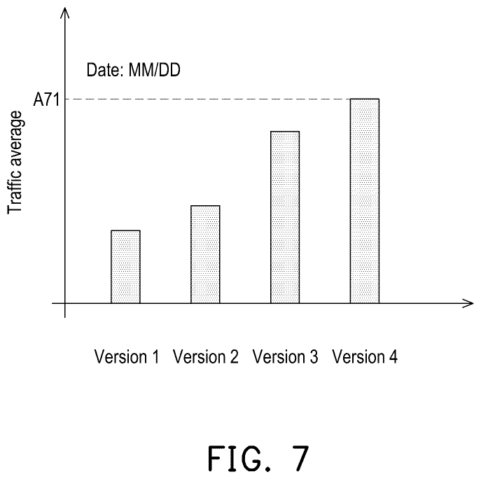

In step S344, when the first version is added to the anomaly version list, the processor 113 may obtain a second average traffic of the first version of the application program in the target unit time period. For example, referring to FIG. 7, which is a schematic diagram illustrating the average traffic of multiple program versions according to an embodiment of the disclosure. Assuming that an application program has released 4 program versions from launch to the present, these mobile electronic devices 120_1 to 120_N may have different versions of the application program installed. Based on the current version in use and corresponding application network traffic reported by each mobile electronic device 120_1 to 120_N, the processor 113 may obtain the second average traffic for each version. For example, the processor 113 may analyze that the second average traffic of “Version 4” on MM/DD is “A71”.

In step S345, the processor 113 may perform a Z-test on the second average traffic of the first version to obtain a Z-value for the first version. Taking FIG. 7 as an example, the processor 113 may perform a Z-test on the second average traffic “A71” of “Version 4” on MM/DD to calculate the corresponding Z-value. Specifically, since different versions are installed in varying numbers across all mobile electronic devices 120_1 to 120_N, when determining whether a certain version is a traffic anomaly version, the processor 113 may perform a statistical test (Z-test) on the average traffic per unit time of that version. This test can effectively judge whether the average traffic of that version significantly exceeds the expected normal range. In some embodiments, the aforementioned Z-test is based on, for example, three times the standard deviation of all samples from all versions.

In step S346, the processor 113 may decide whether the first version is a traffic anomaly version based on the Impact Ratio and Z-value of the first version. Specifically, in some embodiments, the processor 113 may obtain the Impact Ratio and Z-value for each version in the anomaly version list, and rank them according to their Impact Ratios and Z-values. Subsequently, the processor 113 may identify the traffic anomaly version based on the ranking of each version in the anomaly version list.

In summary, in embodiments of the invention, after collecting application network traffic from multiple mobile electronic devices, statistical analysis may be performed on the application network traffic of an application operated by multiple mobile electronic devices to obtain the average traffic per unit time for that application program. Thus, based on the average traffic per unit time obtained through big data analysis of application network traffic from multiple mobile electronic devices, traffic anomaly events of the application program may be detected and traffic anomaly versions of the application program may be identified. On this basis, an objective and reasonable traffic reference for the application program can be obtained, allowing for more accurate determination of whether abnormal network traffic on a mobile electronic device is caused by the application program.

Although the invention has been disclosed in the above embodiments, it is not intended to limit the invention. Any person skilled in the art may make minor modifications and refinements without departing from the spirit and scope of the disclosure. Therefore, the protection scope of the disclosure should be defined by the appended claims.

What is claimed is:

1. A method for detecting abnormal network traffic of an application program, applicable to an electronic device, comprising:
receiving mobile network traffic data of a plurality of mobile electronic devices, wherein the mobile network traffic data of each of the mobile electronic devices comprises application network traffic of an application program;
performing a statistical analysis process on the application network traffic of the application program of the mobile electronic devices, to obtain an average traffic per unit time of a target unit time period for the application program;
determining whether the average traffic per unit time of the target unit time period satisfies a traffic abnormality condition; and
identifying an abnormal traffic version of the application program based on the average traffic per unit time of the target unit time period when the average traffic per unit time of the target unit time period satisfies the traffic abnormality condition.

2. The method for detecting abnormal network traffic of an application program as claimed in claim 1, wherein the application network traffic is background mobile network traffic.

3. The method for detecting abnormal network traffic of an application program as claimed in claim 1, wherein the step of determining whether the average traffic per unit time of the target unit time period satisfies the traffic abnormality condition comprises:
performing the statistical analysis process on the application network traffic of the application program of the mobile electronic devices, to obtain a long-term average traffic associated with a plurality of historical time periods for the application program; and
determining whether the average traffic per unit time of the target unit time period is greater than a threshold value defined based on the long-term average traffic.

4. The method for detecting abnormal network traffic of an application program as claimed in claim 3, wherein the step of determining whether the average traffic per unit time for the target unit time period satisfies the traffic abnormality condition further comprises:
calculating standard deviation data based on the application network traffic of the mobile electronic devices during the plurality of historical time periods; and
determining the threshold value based on the standard deviation data and the long-term average traffic.

5. The method for detecting abnormal network traffic of an application program as claimed in claim 3, wherein the step of determining whether the average traffic per unit time for the target unit time period satisfies the traffic abnormality condition further comprises:
obtaining an increase rate of a moving average of average traffic for the application program based on average traffic per unit time of the application program in a plurality of consecutive unit time periods; and
determining whether the increase rate of the moving average of average traffic is greater than an increase threshold value.

6. The method for detecting abnormal network traffic of an application program as claimed in claim 5, wherein when the average traffic per unit time of the target unit time period is greater than the threshold value defined based on the long-term average traffic, and the increase rate of the moving average of average traffic is greater than the increase threshold value, the average traffic per unit time of the target unit time period satisfies the traffic abnormality condition.

7. The method for detecting abnormal network traffic of an application program as claimed in claim 1, wherein a plurality of program versions of the application program comprise a first version and a plurality of second versions, and the step of identifying the abnormal traffic version of the application program based on the average traffic per unit time of the target unit time period when the average traffic per unit time of the target unit time period satisfies the traffic abnormality condition comprises:
obtaining a first average traffic for the second versions of the application program during the target unit time period, wherein the average traffic per unit time of the target unit time period is based on a statistical result of the program versions; and
determining whether the first version is the abnormal traffic version based on a gap between the average traffic per unit time associated with the program versions and the first average traffic not associated with the first version.

8. The method for detecting abnormal network traffic of an application program as claimed in claim 7, wherein the step of determining whether the first version is the abnormal traffic version based on the gap between the average traffic per unit time associated with the program versions and the first average traffic not associated with the first version comprises:
obtaining an impact ratio for the first version of the application program during the target unit time period based on the gap between the average traffic per unit time and the first average traffic; and
adding the first version to an abnormal version list when the impact ratio of the first version is greater than zero.

9. The method for detecting abnormal network traffic of an application program as claimed in claim 8, wherein the step of determining whether the first version is the abnormal traffic version based on the gap between the average traffic per unit time associated with the program versions and the first average traffic not associated with the first version comprises:
obtaining a second average traffic for the first version of the application program during the target unit time period when the first version is added to the abnormal version list;
performing a Z-test on the second average traffic of the first version to obtain a Z-value for the first version; and
determining whether the first version is the abnormal traffic version based on the impact ratio and the Z-value of the first version.

10. The method for detecting abnormal network traffic of an application program as claimed in claim 1, the method further comprising:
sending a traffic alert notification to at least one of the mobile electronic devices based on the abnormal traffic version of the application program.

11. An electronic device, comprising:
a storage device;
a processor, coupled to the storage device, and configured to:
receive mobile network traffic data of a plurality of mobile electronic devices, wherein the mobile network traffic data of each of the mobile electronic devices comprises application network traffic of an application program;
perform a statistical analysis process on the application network traffic of the application program of the mobile electronic devices, to obtain an average traffic per unit time of a target unit time period for the application program;
determine whether the average traffic per unit time of the target unit time period satisfies a traffic abnormality condition; and
identify an abnormal traffic version of the application program based on the average traffic per unit time of the target unit time period when the average traffic per unit time of the target unit time period satisfies the traffic abnormality condition.
